(19) United States
(12) Patent Application Publication
(10) Pub. No.: US 2007/0213198 A1
(43) Pub. Date: Sep. 13, 2007

(54) Refractory composition

(75) Inventor: David J. Michael, White Oak, PA (US)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Harbison-Walker Refractories Company

(21) Appl. No.: 11/370,351

(22) Filed: Mar. 8, 2006

(51) Int. Cl. C04B 35/482; C04B 35/043

(52) U.S. Cl. 501/104; 501/105; 501/108; 501/120

(57) ABSTRACT

A refractory material, comprised of a refractory material having about 70% to about 96% by weight magnesia particles, about 3% to about 20% by weight fine zirconia particles having a particle size less than 35 Tyler mesh (less than 425 μm), and about 1% to about 8% coarse zirconia or about 1% to about 12% coarse spinel.

### FIELD OF THE INVENTION

The present invention relates to a refractory composition, and more particularly to a refractory composition that finds advantageous application in forming refractory components, such as refractory bricks, for use in kilns and furnaces.

### BACKGROUND OF THE INVENTION

It is known to use chrome-free bricks in rotary cement and lime kilns. These bricks are typically comprised of magnesia in combination with MgO—Al₂O₃ spinel. A problem with such bricks is that cement clinker in a kiln can form low melting compounds with the spinel in the bricks lining the kiln, thereby causing fluxing in the brick and resulting in higher than desired wear of the brick.

U.S. Pat. No. 4,849,383 to Tanemura et al. for BASIC REFRACTORY COMPOSITION discloses a chrome-free brick based upon magnesia in combination with calcium zirconate. This type of brick lacks spinel and exhibits better wear resistance than magnesia-spinel brick. However, a brick as described in U.S. Pat. No. 4,849,383 is relatively expensive because of the high cost of calcium zirconate. As a result, a lower cost brick that exhibits high wear resistance to rotary kiln clinker is desirable.

The present invention provides a basic refractory composition that finds advantageous application in forming refractory brick for use in rotary cement and lime kilns, which brick is less expensive than a magnesia and calcium-zirconate brick.

### SUMMARY OF THE INVENTION

In accordance with a preferred embodiment of the present invention, there is provided a refractory brick, comprised of a refractory material having about 70% to about 96% by weight magnesia particles, about 3% to about 20% by weight fine zirconia particles having a particle size less than 35 Tyler mesh (less than 425 μm), about 1% to about 8% coarse zirconia or about 1% to about 12% coarse spinel.

In accordance with another embodiment of the present invention, there is provided a refractory material, comprised of a refractory material having about 70% to about 96% by weight magnesia particles, about 3% to about 20% by weight fine zirconia particles having a particle size less than 35 Tyler mesh (less than 425 μm), and a binding agent, about 1% to about 8% coarse zirconia or about 1% to about 12% coarse spinel.

An advantage of the present invention is a novel basic refractory composition for use in forming refractory bricks used in a rotary cement and/or lime kiln.

Another advantage of the present invention is a refractory composition as described above that exhibits better wear resistance as compared to magnesia and spinel bricks.

Another advantage of the present invention is a refractory composition as described above that is less expensive than magnesia and calcium-zirconate bricks.

These and other advantages will become apparent from the following description of a preferred embodiment taken together with the accompanying drawings and the appended claims.

### DETAILED DESCRIPTION OF PREFERRED EMBODIMENT

The present invention relates to a basic refractory composition for use in forming refractory bricks and shapes that are used in rotary cement and/or lime kilns. A refractory composition according to the present invention is comprised of about 70% to about 96% by weight magnesia particles, about 3% to about 20% by weight fine zirconia particles and about 1% to about 8% coarse zirconia or about 1% to about 12% coarse spinel.

The magnesia particles in the basic refractory composition may include particles in varying sizes, but the size of the largest particle is preferably less than 9.50 millimeters (0.371 inches). More preferably, the magnesia particles are preferably less than 3 Tyler mesh (i.e., less than 6.70 millimeters). Throughout the specification, particle sizes of certain refractory materials are set forth in Tyler mesh sizes, wherein, by way of example and not limitation, the legend “−3+6 mesh” means a particle size less than 3 Tyler mesh, but greater than 6 Tyler mesh, and the legend “−48 mesh” means a particle size less than 48 Tyler mesh.

The fine zirconia particles may include particles of varying size, but the size of the largest particle is preferably less than 35 Tyler mesh (less than 425 μm). More preferably, the fine zirconia particles are less than 65 Tyler mesh (less than 212 μm).

Coarse spinel or coarse zirconia is added to the foregoing basic refractory composition to improve spalling resistance.

In one embodiment of the present invention, coarse zirconia comprises between about 1% and about 8% by weight of the total refractory composition. As used herein, the term “coarse zirconia” refers to zirconia particles having a particle size between 4 Tyler mesh (4.75 millimeters) and 35 Tyler mesh (425 μm). In this respect, as will be understood by those skilled in the art, most of the refractory materials include trace amounts of particles that may have a particle size larger or smaller than the foregoing range. Preferably, at least 80% of the coarse zirconia has a particle size between 10 Tyler mesh (1.70 millimeters) and 35 Tyler mesh (425 μm). Most preferably, at least 95% of the “coarse zirconia” has a particle size between 10 Tyler mesh (1.70 millimeters) and 35 Tyler mesh (425 μm).

In another embodiment of the present invention, the coarse spinel comprises between about 1% and about 12% by weight of the total refractory composition. The coarse spinel may include particles of varying sizes, but the size of the largest particle is preferably less than 4 Tyler mesh (less than 4.75 millimeters). More preferably, the coarse spinel preferably has a particle size between 6 Tyler mesh (3.35 millimeters) and 28 Tyler mesh (600 μm), although it will be understood by those skilled in the art that some amount of spinel will have particle sizes less than 28 Tyler mesh because some amount of fines is generated during crushing of the spinel.

To form a refractory brick, an organic binder is added to the foregoing basic refractory composition. By way of example and not limitation, the organic binder may be comprised of lignosulfonate, starch, Dextrin, methylcellulose or other known organic binder materials. In a preferred embodiment, the organic binder is lignosulfonate. The refractory composition and binder are then pressed into brick shapes and fired. During firing, the organic binder is oxidized, and the resulting product therefore contains no organic binder.

The present invention shall further be described, together with the following Examples. In the Examples, proportions are set forth in weight percent unless otherwise noted. In the Examples, the fine zirconia has a particle size of less than 35 Tyler mesh (425 μm). The size of the coarse zirconia is set forth in the Examples. The particle sizes of the magnesia and the coarse spinel are also set forth in the Examples.

### EXAMPLE 1

MIX DESIGNATION 1

Percentage (%)

REFRACTORY COMPOSITION

| | |
|---|---|
| Magnesia | |
| −3 + 6 mesh | 7 |
| −6 + 14 mesh | 36 |
| −14 + 48 mesh | 23 |
| −48 mesh | 12 |
| BMF | 15 |
| Fine Zirconia | 7 |
| Coarse Fused Spinel, −6 + 14 mesh | — |
| Coarse Fused Spinel, −14 mesh | — |
| Coarse Zirconia, −10 + 35 mesh | — |
| Additions: | |
| Lignosulfonate | 3.3 |
| Brick Mix Oil | 0.6 |
| Water | 0.2 |

PHYSICAL PROPERTIES

| | |
|---|---|
| Density at the Press, pcf (Av 3): | 195.3 |
| Linear Change in Burning, %: | −0.4 |
| Bulk Density, pcf (Av 6): | 190.0 |
| Modulus of Elasticity, psi × 10⁶ (Av 3): | 10.2 |
| Data from Porosity Test (Av 3): | |
| Bulk Density, pcf: | 192.6 |
| Apparent Porosity, %: | 15.7 |
| Apparent Specific Gravity: | 3.66 |
| Modulus of Rupture, psi (Av 3): | |
| At Room Temperature, psi: | 2190 |
| At 2300° F., psi: | 1890 |
| At 2700° F., psi: | 282 |
| Loss of Strength (soaps), RT to 2200° F., | |
| 5 cycles (Av 3) | |
| Initial MOR, psi: | 2190 |
| Final MOR, psi: | 519 |
| Strength loss, %: | 76.0 |

CHEMICAL ANALYSIS (Calcined Basis)

| | |
|---|---|
| SiO₂ | 0.55 |
| Al₂O₃ | 0.16 |
| TiO₂ | 0.02 |
| Fe₂O₃ | 0.55 |
| Cr₂O₃ | 0.13 |
| ZrO₂ | 6.33 |
| CaO | 2.41 |

### EXAMPLE 2

MIX DESIGNATION 2

Percentage (%)

REFRACTORY COMPOSITION

| | |
|---|---|
| Magnesia | |
| −3 + 6 mesh | 7 |
| −6 + 14 mesh | 36 |
| −14 + 48 mesh | 21 |
| −48 mesh | 12 |
| BMF | 15 |
| Fine Zirconia | 7 |
| Coarse Fused Spinel, −6 + 14 mesh | — |
| Coarse Fused Spinel, −14 mesh | — |
| Coarse Zirconia, −10 + 35 mesh | 2 |
| Additions: | |
| Lignosulfonate | 3.3 |
| Brick Mix Oil | 0.6 |
| Water | 0.2 |

PHYSICAL PROPERTIES

| | |
|---|---|
| Density at the Press, pcf (Av 3): | 195.4 |
| Linear Change in Burning, %: | −0.3 |
| Bulk Density, pcf (Av 6): | 191.7 |
| Modulus of Elasticity, psi × 10⁶ (Av 3): | 4.72 |
| Data from Porosity Test (Av 3): | |
| Bulk Density, pcf: | 192.7 |
| Apparent Porosity, %: | 16.4 |
| Apparent Specific Gravity: | 3.69 |
| Modulus of Rupture, psi (Av 3): | |
| At Room Temperature, psi: | 1220 |
| At 2300° F., psi: | 1420 |
| At 2700° F., psi: | 254 |
| Loss of Strength (soaps), RT to 2200° F., | |
| 5 cycles (Av 3) | |
| Initial MOR, psi: | 1220 |
| Final MOR, psi: | 646 |
| Strength loss, %: | 46.9 |

CHEMICAL ANALYSIS (Calcined Basis)

| | |
|---|---|
| SiO₂ | 0.51 |
| Al₂O₃ | 0.15 |
| TiO₂ | 0.02 |
| Fe₂O₃ | 0.50 |
| Cr₂O₃ | 0.12 |
| ZrO₂ | 7.85 |
| CaO | 2.40 |

### EXAMPLE 3

MIX DESIGNATION 3

Percentage (%)

REFRACTORY COMPOSITION

| | |
|---|---|
| Magnesia | |
| −3 + 6 mesh | 7 |
| −6 + 14 mesh | 36 |
| −14 + 48 mesh | 19 |
| −48 mesh | 12 |
| BMF | 15 |
| Fine Zirconia | 7 |
| Coarse Fused Spinel, −6 + 14 mesh | — |
| Coarse Fused Spinel, −14 mesh | — |
| Coarse Zirconia, −10 + 35 mesh | 4 |
| Additions: | |
| Lignosulfonate | 3.3 |
| Brick Mix Oil | 0.6 |
| Water | 0.2 |

PHYSICAL PROPERTIES

| | |
|---|---|
| Density at the Press, pcf (Av 3): | 197.7 |
| Linear Change in Burning, %: | −0.2 |
| Bulk Density, pcf (Av 6): | 195.2 |
| Modulus of Elasticity, psi × 10⁶ (Av 3): | 3.27 |
| Data from Porosity Test (Av 3): | |
| Bulk Density, pcf: | 194.2 |
| Apparent Porosity, %: | 16.4 |
| Apparent Specific Gravity: | 3.72 |
| Modulus of Rupture, psi (Av 3): | |
| At Room Temperature, psi: | 1000 |
| At 2300° F., psi: | 1130 |
| At 2700° F., psi: | 312 |
| Loss of Strength (soaps), RT to 2200° F., | |
| 5 cycles (Av 3) | |
| Initial MOR, psi: | 1000 |
| Final MOR, psi: | 540 |
| Strength loss, %: | 46.1 |

CHEMICAL ANALYSIS (Calcined Basis)

| | |
|---|---|
| SiO₂ | 0.54 |
| Al₂O₃ | 0.16 |
| TiO₂ | 0.02 |
| Fe₂O₃ | 0.50 |
| Cr₂O₃ | 0.12 |
| ZrO₂ | 8.99 |
| CaO | 2.44 |

### EXAMPLE 4

MIX DESIGNATION 4

Percentage (%)

REFRACTORY COMPOSITION

| | |
|---|---|
| Magnesia | |
| −3 + 6 mesh | 7 |
| −6 + 14 mesh | 34 |
| −14 + 48 mesh | 22 |
| −48 mesh | 12 |
| BMF | 15 |
| Fine Zirconia | 7 |
| Coarse Fused Spinel, −6 + 14 mesh | 2 |
| Coarse Fused Spinel, −14 mesh | 1 |
| Coarse Zirconia, −10 + 35 mesh | — |
| Additions: | |
| Lignosulfonate | 3.3 |
| Brick Mix Oil | 0.6 |
| Water | 0.2 |

PHYSICAL PROPERTIES

| | |
|---|---|
| Density at the Press, pcf (Av 3): | 194.3 |
| Linear Change in Burning, %: | −0.3 |
| Bulk Density, pcf (Av 6): | 190.2 |
| Modulus of Elasticity, psi × 10⁶ (Av 3): | 6.24 |
| Data from Porosity Test (Av 3): | |
| Bulk Density, pcf: | 190.6 |
| Apparent Porosity, %: | 16.6 |
| Apparent Specific Gravity: | 3.66 |
| Modulus of Rupture, psi (Av 3): | |
| At Room Temperature, psi: | 1230 |
| At 2300° F., psi: | 1490 |
| At 2700° F., psi: | 210 |
| Loss of Strength (soaps), RT to 2200° F., | |
| 5 cycles (Av 3) | |
| Initial MOR, psi: | 1230 |
| Final MOR, psi: | 783 |
| Strength loss, %: | 35.6 |

CHEMICAL ANALYSIS (Calcined Basis)

| | |
|---|---|
| SiO₂ | 0.51 |
| Al₂O₃ | 2.51 |
| TiO₂ | 0.02 |
| Fe₂O₃ | 0.51 |
| Cr₂O₃ | 0.13 |
| ZrO₂ | 6.23 |
| CaO | 2.34 |

### EXAMPLE 5

MIX DESIGNATION 5

Percentage (%)

REFRACTORY COMPOSITION

| | |
|---|---|
| Magnesia | |
| −3 + 6 mesh | 7 |
| −6 + 14 mesh | 30 |
| −14 + 48 mesh | 21 |
| −48 mesh | 12 |
| BMF | 15 |
| Fine Zirconia | 7 |
| Coarse Fused Spinel, −6 + 14 mesh | 6 |
| Coarse Fused Spinel, −14 mesh | 2 |
| Coarse Zirconia, −10 + 35 mesh | — |
| Additions: | |
| Lignosulfonate | 3.3 |
| Brick Mix Oil | 0.6 |
| Water | 0.2 |

PHYSICAL PROPERTIES

| | |
|---|---|
| Density at the Press, pcf (Av 3): | 195.5 |
| Linear Change in Burning, %: | −0.3 |
| Bulk Density, pcf (Av 6): | 189.9 |
| Modulus of Elasticity, psi × 10⁶ (Av 3): | 3.36 |
| Data from Porosity Test (Av 3): | |
| Bulk Density, pcf: | 191.6 |
| Apparent Porosity, %: | 16.2 |
| Apparent Specific Gravity: | 3.66 |
| Modulus of Rupture, psi (Av 3): | |
| At Room Temperature, psi: | 888 |
| At 2300° F., psi: | 953 |
| At 2700° F., psi: | 184 |
| Loss of Strength (soaps), RT to 2200° F., | |
| 5 cycles (Av 3) | |
| Initial MOR, psi: | 888 |
| Final MOR, psi: | 575 |
| Strength loss, %: | 35.2 |

CHEMICAL ANALYSIS (Calcined Basis)

| | |
|---|---|
| SiO₂ | 0.54 |
| Al₂O₃ | 6.20 |
| TiO₂ | 0.02 |
| Fe₂O₃ | 0.51 |
| Cr₂O₃ | 0.12 |
| ZrO₂ | 6.17 |
| CaO | 2.24 |

### EXAMPLE 6

MIX DESIGNATION 6

Percentage (%)

REFRACTORY COMPOSITION

| | |
|---|---|
| Magnesia | |
| −3 + 6 mesh | 7 |
| −6 + 14 mesh | 36 |
| −14 + 48 mesh | 23 |
| −48 mesh | 12 |
| BMF | 8 |
| Fine Zirconia | 14 |
| Coarse Fused Spinel, −6 + 14 mesh | — |
| Coarse Fused Spinel, −14 mesh | — |
| Coarse Zirconia, −10 + 35 mesh | — |
| Additions: | |
| Lignosulfonate | 3.3 |
| Brick Mix Oil | 0.6 |
| Water | 0.2 |

PHYSICAL PROPERTIES

| | |
|---|---|
| Density at the Press, pcf (Av 3): | 200.7 |
| Linear Change in Burning, %: | −0.3 |
| Bulk Density, pcf (Av 6): | 195.8 |
| Modulus of Elasticity, psi × 10⁶ (Av 3): | 3.38 |
| Data from Porosity Test (Av 3): | |
| Bulk Density, pcf: | 197.4 |
| Apparent Porosity, %: | 15.5 |
| Apparent Specific Gravity: | 3.74 |
| Modulus of Rupture, psi (Av 3): | |
| At Room Temperature, psi: | 1140 |
| At 2300° F., psi: | 1760 |
| At 2700° F., psi: | 314 |
| Loss of Strength (soaps), RT to 2200° F., | |
| 5 cycles (Av 3) | |
| Initial MOR, psi: | 1140 |
| Final MOR, psi: | 381 |
| Strength loss, %: | 66.5 |

CHEMICAL ANALYSIS (Calcined Basis)

| | |
|---|---|
| SiO₂ | 0.55 |
| Al₂O₃ | 0.16 |
| TiO₂ | 0.02 |
| Fe₂O₃ | 0.51 |
| Cr₂O₃ | 0.11 |
| ZrO₂ | 12.47 |
| CaO | 2.33 |

### EXAMPLE 7

MIX DESIGNATION 7

Percentage (%)

REFRACTORY COMPOSITION

| | |
|---|---|
| Magnesia | |
| −3 + 6 mesh | 7 |
| −6 + 14 mesh | 36 |
| −14 + 48 mesh | 21 |
| −48 mesh | 12 |
| BMF | 8 |
| Fine Zirconia | 14 |
| Coarse Fused Spinel, −6 + 14 mesh | — |
| Coarse Fused Spinel, −14 mesh | — |
| Coarse Zirconia, −10 + 35 mesh | 2 |
| Additions: | |
| Lignosulfonate | 3.3 |
| Brick Mix Oil | 0.6 |
| Water | 0.2 |

PHYSICAL PROPERTIES

| | |
|---|---|
| Density at the Press, pcf (Av 3): | 201.9 |
| Linear Change in Burning, %: | −0.1 |
| Bulk Density, pcf (Av 6): | 196.1 |
| Modulus of Elasticity, psi × 10⁶ (Av 3): | 2.10 |
| Data from Porosity Test (Av 3): | |
| Bulk Density, pcf: | 198.3 |
| Apparent Porosity, %: | 15.7 |
| Apparent Specific Gravity: | 3.77 |
| Modulus of Rupture, psi (Av 3): | |
| At Room Temperature, psi: | 737 |
| At 2300° F., psi: | 1420 |
| At 2700° F., psi: | 222 |
| Loss of Strength (soaps), RT to 2200° F., | |
| 5 cycles (Av 3) | |
| Initial MOR, psi: | 738 |
| Final MOR, psi: | 409 |
| Strength loss, %: | 44.5 |

CHEMICAL ANALYSIS (Calcined Basis)

| | |
|---|---|
| SiO₂ | 0.58 |
| Al₂O₃ | 0.16 |
| TiO₂ | 0.03 |
| Fe₂O₃ | 0.54 |
| Cr₂O₃ | 0.12 |
| ZrO₂ | 14.10 |
| CaO | 2.35 |

### EXAMPLE 8

MIX DESIGNATION 8

Percentage (%)

REFRACTORY COMPOSITION

| | |
|---|---|
| Magnesia | |
| −3 + 6 mesh | 7 |
| −6 + 14 mesh | 36 |
| −14 + 48 mesh | 19 |
| −48 mesh | 12 |
| BMF | 8 |
| Fine Zirconia | 14 |
| Coarse Fused Spinel, −6 + 14 mesh | — |
| Coarse Fused Spinel, −14 mesh | — |
| Coarse Zirconia, −10 + 35 mesh | 4 |
| Additions: | |
| Lignosulfonate | 3.3 |
| Brick Mix Oil | 0.6 |
| Water | 0.2 |

PHYSICAL PROPERTIES

| | |
|---|---|
| Density at the Press, pcf (Av 3): | 203.3 |
| Linear Change in Burning, %: | 0.0 |
| Bulk Density, pcf (Av 6): | 196.8 |
| Modulus of Elasticity, psi × 10⁶ (Av 3): | 1.53 |
| Data from Porosity Test (Av 3): | |
| Bulk Density, pcf: | 197.9 |
| Apparent Porosity, %: | 16.5 |
| Apparent Specific Gravity: | 3.79 |
| Modulus of Rupture, psi (Av 3): | |
| At Room Temperature, psi: | 591 |
| At 2300° F., psi: | 1050 |
| At 2700° F., psi: | 271 |
| Loss of Strength (soaps), RT to 2200° F., | |
| 5 cycles (Av 3) | |
| Initial MOR, psi: | 591 |
| Final MOR, psi: | 371 |
| Strength loss, %: | 37.1 |

CHEMICAL ANALYSIS (Calcined Basis)

| | |
|---|---|
| SiO₂ | 0.49 |
| Al₂O₃ | 1.21 |
| TiO₂ | 0.03 |
| Fe₂O₃ | 0.49 |
| Cr₂O₃ | 0.11 |
| ZrO₂ | 14.51 |
| CaO | 2.29 |

### EXAMPLE 9

MIX DESIGNATION 9

Percentage (%)

REFRACTORY COMPOSITION

| | |
|---|---|
| Magnesia | |
| −3 + 6 mesh | 7 |
| −6 + 14 mesh | 34 |
| −14 + 48 mesh | 22 |
| −48 mesh | 12 |
| BMF | 8 |
| Fine Zirconia | 14 |
| Coarse Fused Spinel, −6 + 14 mesh | 2 |
| Coarse Fused Spinel, −14 mesh | 1 |
| Coarse Zirconia, −10 + 35 mesh | — |
| Additions: | |
| Lignosulfonate | 3.3 |
| Brick Mix Oil | 0.6 |
| Water | 0.2 |

PHYSICAL PROPERTIES

| | |
|---|---|
| Density at the Press, pcf (Av 3): | 202.0 |
| Linear Change in Burning, %: | −0.2 |
| Bulk Density, pcf (Av 6): | 195.7 |
| Modulus of Elasticity, psi × 10⁶ (Av 3): | 2.56 |
| Data from Porosity Test (Av 3): | |
| Bulk Density, pcf: | 197.0 |
| Apparent Porosity, %: | 15.5 |
| Apparent Specific Gravity: | 3.74 |
| Modulus of Rupture, psi (Av 3): | |
| At Room Temperature, psi: | 845 |
| At 2300° F., psi: | 1340 |
| At 2700° F., psi: | 311 |
| Loss of Strength (soaps), RT to 2200° F., | |
| 5 cycles (Av 3) | |
| Initial MOR, psi: | 846 |
| Final MOR, psi: | 434 |
| Strength loss, %: | 48.3 |

CHEMICAL ANALYSIS (Calcined Basis)

| | |
|---|---|
| SiO₂ | 0.51 |
| Al₂O₃ | 2.35 |
| TiO₂ | 0.02 |
| Fe₂O₃ | 0.45 |
| Cr₂O₃ | 0.11 |
| ZrO₂ | 12.28 |
| CaO | 2.26 |

### EXAMPLE 10

MIX DESIGNATION 10

Percentage (%)

REFRACTORY COMPOSITION

| | |
|---|---|
| Magnesia | |
| −3 + 6 mesh | 7 |
| −6 + 14 mesh | 30 |
| −14 + 48 mesh | 21 |
| −48 mesh | 12 |
| BMF | 8 |
| Fine Zirconia | 14 |
| Coarse Fused Spinel, −6 + 14 mesh | 6 |
| Coarse Fused Spinel, −14 mesh | 2 |
| Coarse Zirconia, −10 + 35 mesh | — |
| Additions: | |
| Lignosulfonate | 3.3 |
| Brick Mix Oil | 0.6 |
| Water | 0.2 |

PHYSICAL PROPERTIES

| | |
|---|---|
| Density at the Press, pcf (Av 3): | 202.1 |
| Linear Change in Burning, %: | −0.1 |
| Bulk Density, pcf (Av 6): | 195.6 |
| Modulus of Elasticity, psi × 10⁶ (Av 3): | 1.85 |
| Data from Porosity Test (Av 3): | |
| Bulk Density, pcf: | 196.4 |
| Apparent Porosity, %: | 16.0 |
| Apparent Specific Gravity: | 3.74 |
| Modulus of Rupture, psi (Av 3): | |
| At Room Temperature, psi: | 622 |
| At 2300° F., psi: | 872 |
| At 2700° F., psi: | 248 |
| Loss of Strength (soaps), RT to 2200° F., | |
| 5 cycles (Av 3) | |
| Initial MOR, psi: | 622 |
| Final MOR, psi: | 419 |
| Strength loss, %: | 34.7 |

CHEMICAL ANALYSIS (Calcined Basis)

| | |
|---|---|
| SiO₂ | 0.47 |
| Al₂O₃ | 6.22 |
| TiO₂ | 0.03 |
| Fe₂O₃ | 0.46 |
| Cr₂O₃ | 0.16 |
| ZrO₂ | 13.12 |
| CaO | 2.07 |

Examples 1 and 6 show refractory compositions that do not include either the coarse spinel or coarse zirconia. The percent (%) loss of strength of these compositions after five (5) thermal cycles, is shown in the Examples. As shown, Mix Designation 1 exhibited a 76.0% difference (loss) between its initial Modulus of Rupture (MOR) and its final Modulus of Rupture (MOR). Mix Designation 6 exhibited a 66.5% loss of strength. As shown in the other Examples, mixes that included coarse spinel or coarse zirconia exhibited lower percentage loss of strength. As will be appreciated by those skilled in the art, refractory bricks that exhibit a high loss of strength are more susceptible to spalling.

The foregoing descriptions describe specific embodiments of the present invention. It should be appreciated that these embodiments are described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. A refractory brick, comprised of a refractory material having:
about 70% to about 96% by weight magnesia particles;
about 3% to about 20% by weight fine zirconia particles having a particle size less than 35 Tyler mesh (less than 425 μm); and
about 1% to about 8% coarse zirconia or about 1% to about 12% coarse spinel.

2. A refractory brick as described in claim 1, wherein said refractory material has about 1% to about 8% by weight coarse spinel.

3. A refractory brick as described in claim 1, wherein said refractory material has about 1% to about 4% by weight coarse zirconia.

4. A refractory brick as described in claim 1, wherein said refractory material is comprised of:
about 7% by weight magnesia particles between 3 Tyler mesh and 6 Tyler mesh;
about 30% to about 36% by weight magnesia particles between 6 Tyler mesh and 14 Tyler mesh;
about 19% to about 23% by weight magnesia particles between 14 Tyler mesh and 48 Tyler mesh; and
about 20% to about 27% by weight magnesia particles less than 48 Tyler mesh.

5. A refractory brick as described in claim 4, wherein fine zirconia particles comprise about 7% to about 14% by weight of said refractory material.

6. A refractory brick as described in claim 5, further comprising coarse spinel having particles sized less than 6 Tyler mesh (3.35 millimeters).

7. A refractory brick as described in claim 5, further comprising coarse spinel having particles sized between 6 Tyler mesh (3.35 millimeters) and 28 Tyler mesh (600 μm), said spinel comprising about 3% to about 8% by weight of said refractory material.

8. A refractory brick as described in claim 5, further comprising coarse zirconia, said coarse zirconia comprising about 2% to about 4% by weight of said refractory material.

9. A refractory material, comprised of:
about 70% to about 96% by weight magnesia particles;
about 4% to about 20% by weight fine zirconia particles having a particle size less than 35 Tyler mesh (less than 425 μm); and
about 3% to about 8% by weight of coarse spinel having particles sized less than 6 Tyler mesh (3.35 millimeters).

10. A refractory material, comprised of:
about 70% to about 96% by weight magnesia particles;
about 3% to about 20% by weight fine zirconia particles having a particle size less than 35 Tyler mesh (less than 425 μm); and
about 2% to about 8% by weight of coarse zirconia.

11. A refractory material as described in claims 9 or 10, comprised of:
about 7% by weight magnesia particles between 3 Tyler mesh and 6 Tyler mesh;
about 30% to about 36% by weight magnesia particles between 6 Tyler mesh and 14 Tyler mesh;
about 19% to about 23% by weight magnesia particles between 14 Tyler mesh and 48 Tyler mesh; and
about 20% to about 27% by weight magnesia particles less than 48 Tyler mesh.

12. A refractory material as described in claim 11, wherein fine zirconia particles comprise about 7% to about 14% by weight of said refractory material.
